(19) United States
(12) Patent Application Publication
(10) Pub. No.: US 2010/0111436 A1
(43) Pub. Date: May 6, 2010

(54) METHOD AND APPARATUS FOR REMOVING MOTION COMPENSATION NOISE OF IMAGE BY USING WAVELET TRANSFORM

(75) Inventor: Young-je Jung, Changwon-city (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/425,523

(22) Filed: Apr. 17, 2009

(30) Foreign Application Priority Data
Nov. 6, 2008 (KR) 10-2008-0110025

(51) Int. Cl. G06K 9/40

(52) U.S. Cl. 382/263

(57) ABSTRACT

Provided are a method and apparatus for removing motion compensation noise of an image by using wavelet transform, thereby preventing an image from being blurred or an afterimage from being generated. The apparatus for removing motion compensation noise of an image by using wavelet transform includes a wavelet transform unit filtering an input image to generate sub-images, a motion predicting unit predicting a motion of previous and present low frequency sub-band sub-images (of the sub-images and generating a region of interest (ROI) binary image, a noise removing unit selectively removing noise from high frequency sub-band sub-images of the sub-images according to the ROI image, and a wavelet inverse-transform unit combining the sub-images from which noise is removed and generating an output image.

### CROSS-REFERENCE TO RELATED PATENT APPLICATION

This application claims the benefit of Korean Patent Application No. 10-2008-0110025, filed on Nov. 6, 2008, in the Korean Intellectual Property Office, the disclosure of which is incorporated herein in its entirety by reference.

### BACKGROUND OF THE INVENTION

1. Field of the Invention

The present invention relates to a method and apparatus for removing motion compensation noise of an image by using wavelet transform.

2. Description of the Related Art

Under low intensity illumination, an image sensor amplifies output thereof in order to amplify a video signal. At this time, gain noise is generated on a screen. In general, the gain noise is removed by performing NXN space filtering on a temporal axis.

With regard to a moving picture, filtering is performed on the temporal axis with respect to edges of a moving object and an image, as well as the gain noise caused by amplifying the video signal, and thus, an image is blurred. In addition, the more the image moves, the more the image is filtered, which causes an afterimage.

### SUMMARY OF THE INVENTION

The present invention provides a method and apparatus for predicting motion of an image and removing motion compensation noise of the image by using wavelet transform.

According to an aspect of the present invention, there is provided an apparatus for removing motion compensation noise of an image by using wavelet transform, the apparatus including a wavelet transform unit filtering an input image to generate sub-images; a motion predicting unit predicting a motion of previous and present low frequency sub-band sub-images of the sub-images and generating a region of interest (ROI) binary image; a noise removing unit selectively removing noise from high frequency sub-band sub-images of the sub-images according to the ROI image; and a wavelet inverse-transform unit combining the sub-images from which noise is removed and generating an output image.

The motion predicting unit may include a motion vector processing unit generating a motion prediction vector from the previous and present low frequency sub-band images and normalizing the motion prediction vector; and an image generating unit comparing the normalized motion prediction vector with a reference value, generating an ROI binary image representing 0 if the motion prediction vector is less than the reference value, and generating an ROI binary image representing 1 if the motion prediction vector is not less than the reference value.

The noise removing unit may remove noise from high frequency sub-band images of the sub-images according to the ROI binary image by using a previously established noise attenuation curve.

According to another aspect of the present invention, there is provided a method of removing motion compensation noise of an image by using wavelet transform, the method including performing wavelet transform on an input image to generate sub-images; predicting a motion of previous and present low frequency sub-band images of the sub-images and generating an ROI image; selectively removing noise from high frequency sub-band images of the sub-images according to the ROI image; and performing inverse wavelet transform on the sub-images from which noise is removed and generating an output image.

The predicting may include generating a motion prediction vector from the previous and present low frequency sub-band images and normalizing the motion prediction vector; and comparing the normalized motion prediction vector with a reference value, generating an ROI binary image representing 0 if the motion prediction vector is less than the reference value, and generating an ROI binary image representing 1 if the motion prediction vector is not less than the reference value.

The selectively removing may include removing noise from high frequency sub-band images of the sub-images according to the ROI binary image by using a previously established noise attenuation curve.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an apparatus for removing motion compensation noise of an image by using a wavelet transform, according to an embodiment of the present invention;

FIGS. 2A through 2G are images showing that the apparatus of FIG. 1 predicts a motion of an image and generates a region of interest (ROI) binary image, according to an embodiment of the present invention;

FIGS. 3G, 3H, and 3I are images showing that the apparatus of FIG. 1 selectively removes noise, according to an embodiment of the present invention;

FIGS. 4A and 4B are graphs of previously established noise attenuation curves used to selectively remove noise in the apparatus of FIG. 1, according to an embodiment of the present invention; and

FIG. 5 is a flowchart illustrating a method of removing motion compensation noise of an image by using wavelet transform, according to an embodiment of the present invention.

### DETAILED DESCRIPTION OF THE INVENTION

Hereinafter, the present invention will be described in detail by explaining exemplary embodiments of the invention with reference to the attached drawings.

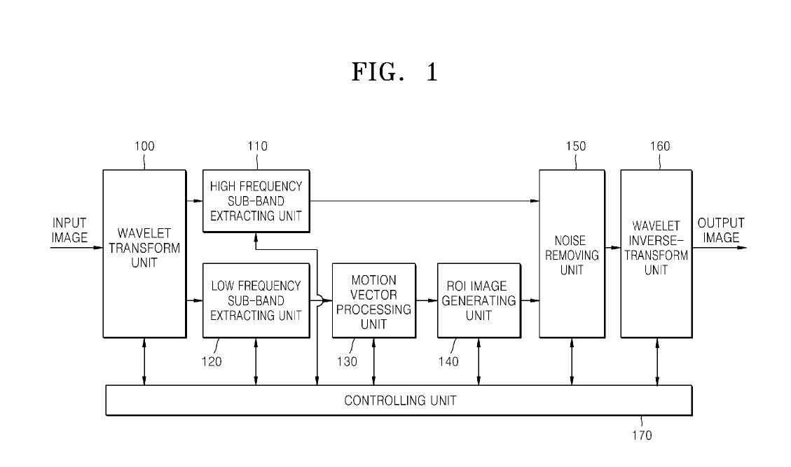

FIG. 1 is a block diagram of an apparatus for removing motion compensation noise of an image by using wavelet transform, according to an embodiment of the present invention. The apparatus according to the present embodiment includes a wavelet transform unit 100, a high frequency sub-band extracting unit 110, a low frequency sub-band extracting unit 120, a motion vector processing unit 130, a region of interest (ROI) image generating unit 140, a noise removing unit 150, a wavelet inverse-transform unit 160 and a controlling unit 170.

The wavelet transform unit 100 filters an input image to generate sub-images. The wavelet transform unit 100 applies a low-pass filer and a high-pass filter to each row of a two-dimensional image and performs down-sampling to generate a low-low (LL) image as a low frequency sub-band sub-image and a low-high (LH) image, a high-low (HL) image and a high-high (HH) image as high frequency sub-band sub-images.

The LL image is sub-sampled to 2 by applying the low-pass filter to an original image in horizontal and vertical directions. The HL image is generated by applying the high-pass filter to the original image in the vertical direction, and includes an error component of a frequency in the vertical direction. The LH image is generated by applying the high-pass filter to the original image in the horizontal direction, and includes an error component of a frequency in the horizontal direction. The HH image is generated by applying the high-pass filter to the original image in the horizontal and vertical directions.

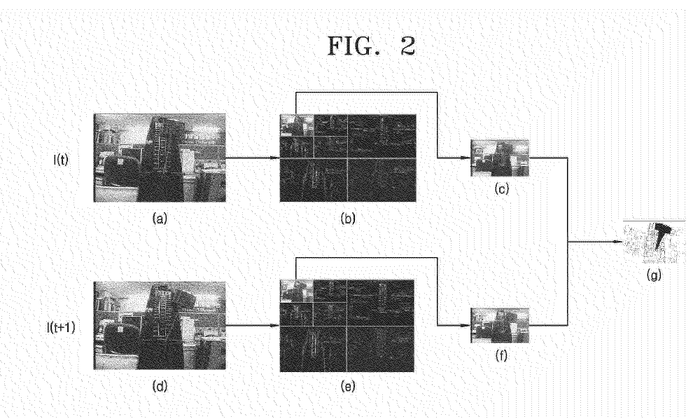

FIGS. 2A and 2D are a previous original image (I(t)) and a present original image (I(t+1)), and FIGS. 2B and 2E are wavelet transform sub-images of the previous original image (I(t)) and the present original image (I(t+1)), according to an embodiment of the present invention.

The high frequency sub-band extracting unit 110 extracts the high frequency sub-band sub-images, that is, the LH, HL and HH images from among the wavelet transform sub-images.

The low frequency sub-band extracting unit 120 extracts the low frequency sub-band image, that is, the LL image from among the wavelet transform sub-images. As described above, since the low frequency sub-band image includes spatial information, motion information between frames can be obtained.

FIGS. 2C and 2F are low frequency sub-band images among the wavelet transform sub-images, according to an embodiment of the present invention.

The motion vector processing unit 130 generates a motion prediction vector with respect to the low frequency sub-band image of the previous original image (I(t)) and the present original image (I(t+1)), and normalizes the motion prediction vector.

The ROI image generating unit 140 compares the normalized motion prediction vector with a reference value. When the motion prediction vector is less than the reference value, the ROI image generating unit 140 generates an ROI binary image representing 0. Otherwise, when the motion prediction vector is not less than the reference value, the ROI image generating unit 140 generates an ROI binary image representing 1. FIG. 2G is the ROI binary image that is generated according to the reference value by generating and normalizing the motion prediction vector with respect to the low frequency sub-band images of FIGS. 2C and 2F, according to an embodiment of the present invention.

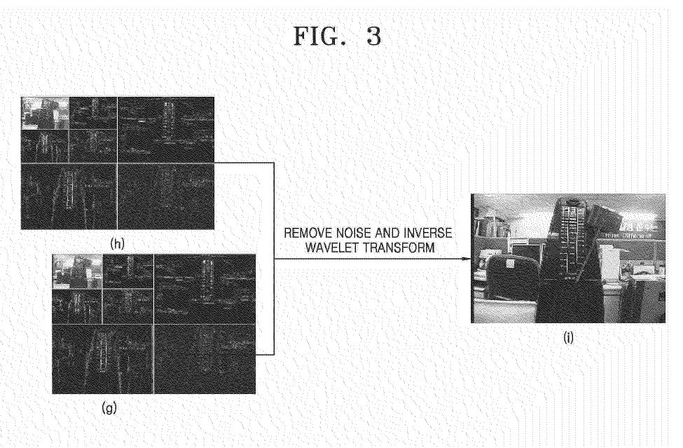

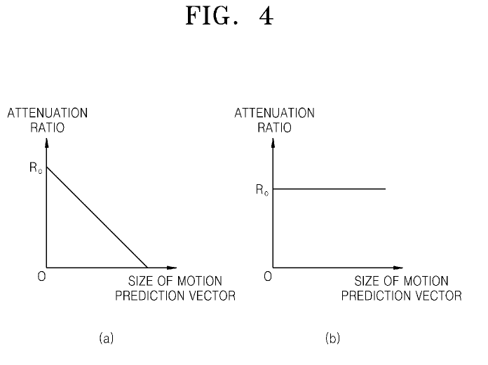

The noise removing unit 150 selectively removes noise from high frequency sub-band images that are extracted by the high frequency sub-band extracting unit 110 of FIG. 3H according to an ROI binary image of FIG. 3G. Noise attenuation curves illustrated in FIGS. 4A and 4B are previously stored in the controlling unit 170. When the ROI binary image represents 1, noise is removed by applying the noise attenuation curve illustrated in FIG. 4A to the ROI binary image. When the ROI binary image represents 0, noise is removed by applying the noise attenuation curve illustrated in FIG. 4B to the ROI binary image.

In addition, motion information of the low frequency sub-band image is identical to spatial information of another high frequency sub-band image, thereby determining wavelet coefficients including motion information of the high frequency sub-band image, and selectively applying a reference value to an amount of motion of the motion information.

The wavelet inverse-transform unit 160 combines the four sub-images from which noise is removed to restore and output an original image. FIG. 3I is an inverse wavelet transform image from which noise has been removed. Noise is removed from the inverse wavelet transform image, compared to the images of FIGS. 2A and 2D.

The controlling unit 170 controls operations of all elements, and, in particular, stores the noise attenuation curves.

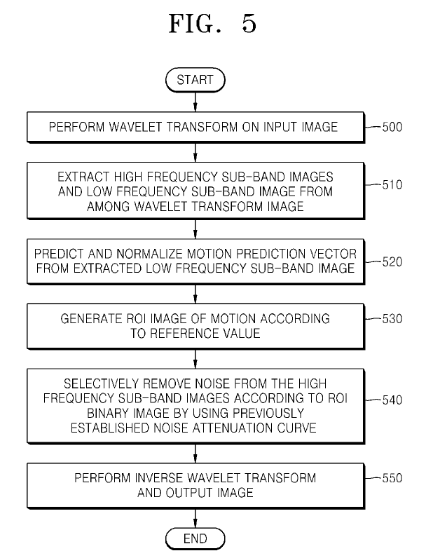

Hereinafter, a method of removing motion compensation noise of an image by using wavelet transform will be described with reference to FIG. 5.

The wavelet transform unit 100 filters an input image to generate sub-images (Operation 500).

The wavelet transform unit 100 applies a low-pass filer and a high-pass filter to each row of a two-dimensional image and performs down-sampling to generate an LL image as a low frequency sub-band sub-image and an LH image, an HL image and a HH image as high frequency sub-band sub-images.

After the previous original image (I(t)) and the present original image (I(t+1)) are completely wavelet transformed, the high frequency sub-band extracting unit 110 extracts the high frequency sub-band images from among the wavelet transform sub-images, and extracts the low frequency sub-band image from among the wavelet transform sub-images (operation 510).

Since the low frequency sub-band image includes spatial information, motion information between frames can be obtained. FIGS. 2C and 2F are low frequency sub-band images of the wavelet transform sub-images, according to an embodiment of the present invention. After the high frequency sub-band images and the low frequency sub-band image are completely extracted, the motion vector processing unit 130 generates a motion prediction vector with respect to a low frequency sub-band image of the previous original image (I(t)) and the present original image (I(t+1)), and normalizes the motion prediction vector (operation 520).

Then, the ROI image generating unit 140 compares the normalized motion prediction vector with a reference value. When the motion prediction vector is less than the reference value, the ROI image generating unit 140 generates an ROI binary image representing 0. Otherwise, when the motion prediction vector is not less than the reference value, the ROI image generating unit 140 generates an ROI binary image representing 1 (operation 530).

FIG. 2G is the ROI binary image that is generated according to the reference value by generating and normalizing the motion prediction vector with respect to the low frequency sub-band images of FIGS. 2C and 2F, according to an embodiment of the present invention.

After the ROI binary image is generated, the noise removing unit 150 selectively removes noise from high frequency sub-band images that are extracted by the high frequency sub-band extracting unit 110 of FIG. 3H according to an ROI binary image of FIG. 3G (operation 540).

The noise attenuation curves illustrated in FIGS. 4A and 4B are previously stored in the controlling unit 170. When the ROI binary image represents 1, noise is removed by applying the noise attenuation curve illustrated in FIG. 4A to the ROI binary image. When the ROI binary image represents 0, noise is removed by applying the noise attenuation curve illustrated in FIG. 4B to the ROI binary image. In addition, motion information of the low frequency sub-band image is identical to spatial information of another high frequency sub-band image, thereby determining wavelet coefficients including motion information of the high frequency sub-band image, and selectively applying a reference value to an amount of motion of the motion information.

After the noise is removed, the wavelet inverse-transform unit 160 combines the four sub-images from which noise is removed to restore an original image and generate an output image (operation 550).

FIG. 3I illustrates an inverse wavelet transform image from which noise has been removed. Noise is removed from the inverse wavelet transform image, compared to the images of FIGS. 2A and 2D.

As described above, noise is removed by predicting motion of a moving picture by using wavelet transform, thereby preventing an image from being blurred or an afterimage from being generated.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. An apparatus for removing motion compensation noise of an image by using wavelet transform, the apparatus comprising:
a wavelet transform unit filtering an input image to generate sub-images;
a motion predicting unit predicting a motion of previous and present low frequency sub-band sub-images of the sub-images and generating a region of interest binary image;
a noise removing unit selectively removing noise from high frequency sub-band sub-images of the sub-images according to the region of interest binary image; and
a wavelet inverse-transform unit combining the sub-images from which noise is removed and generating an output image.

2. The apparatus of claim 1, wherein the motion predicting unit comprises:
a motion vector processing unit generating a motion prediction vector from the previous and present low frequency sub-band images and normalizing the motion prediction vector; and
an image generating unit comparing the normalized motion prediction vector with a reference value, generating the region of interest binary image representing 0 if the motion prediction vector is less than the reference value, and generating the region of interest binary image representing 1 if the motion prediction vector is not less than the reference value.

3. The apparatus of claim 2, wherein the noise removing unit removes noise from high frequency sub-band images of the sub-images according to the region of interest binary image by using a previously established noise attenuation curve.

4. A method of removing motion compensation noise of an image by using wavelet transform, the method comprising:
performing wavelet transform on an input image to generate sub-images;
predicting a motion of previous and present low frequency sub-band images of the sub-images and generating an ROI image;
selectively removing noise from high frequency sub-band images of the sub-images according to the ROI image; and
performing inverse wavelet transform on the sub-images from which noise is removed and generating an output image.

5. The method of claim 4, wherein the predicting comprises:
generating a motion prediction vector from the previous and present low frequency sub-band images and normalizing the motion prediction vector; and
comparing the normalized motion prediction vector with a reference value, generating an ROI binary image representing 0 if the motion prediction vector is less than the reference value, and generating an ROI binary image representing 1 if the motion prediction vector is not less than the reference value.

6. The method of claim 5, wherein the selectively removing comprises removing noise from high frequency sub-band images of the sub-images according to the ROI binary image by using a previously established noise attenuation curve.

7. An apparatus for removing motion compensation noise of an image by using wavelet transform, the apparatus comprising:
a means for filtering an input image to generate sub-images;
a means for predicting a motion of previous and present low frequency sub-band sub-images of the sub-images and generating a region of interest binary image;
a means for selectively removing noise from high frequency sub-band sub-images of the sub-images according to the region of interest binary image; and
a means for combining the sub-images from which noise is removed and generating an output image.

8. The apparatus of claim 7, wherein the means for predicting unit comprises:
a means for generating a motion prediction vector from the previous and present low frequency sub-band images and normalizing the motion prediction vector; and
a means for comparing the normalized motion prediction vector with a reference value, generating the region of interest binary image representing 0 if the motion prediction vector is less than the reference value, and generating the region of interest binary image representing 1 if the motion prediction vector is not less than the reference value.

9. The apparatus of claim 8, wherein the means for selectively removing noise removes noise from high frequency sub-band images of the sub-images according to the region of interest binary image by using a previously established noise attenuation curve.
